(19) United States
(12) Patent Application Publication
(10) Pub. No.: US 2015/0270600 A1
(43) Pub. Date: Sep. 24, 2015

(54) PERSONAL ELECTRONIC DEVICE

(71) Applicant: TSUNG-MING WU, Nantou County (TW)

(72) Inventor: TSUNG-MING WU, Nantou County (TW)

(21) Appl. No.: 14/222,592

(22) Filed: Mar. 22, 2014

(51) Int. Cl. H01Q 1/24

(52) U.S. Cl. CPC H01Q 1/243

(57) ABSTRACT

A personal electronic device has its modules wirelessly connected for communications between the modules. The personal electronic device comprises a frame module, a peripheral module, a battery unit, and a plurality of power lines. The frame module and the peripheral module are each equipped with a wireless chipset and an antenna. The communication between the frame module and the peripheral module is accomplished only through wireless signals. There are no wires and sockets for connecting the frame module to the peripheral module. Costs related to wires and sockets manufacture and installation are thereby reduced.

### BACKGROUND OF THE INVENTION

The instant disclosure relates to a personal electronic device, and more specifically, to a personal electronic device having its modules wirelessly connected for communications between the modules.

A personal electronic device nowadays comprises of a cover, a frame, a mother board, and a variety of peripheral units such as a display unit, a camera unit, a wireless communication unit, a sensor unit, and etc. A mother board is a printed circuit board (“PCB”) with a variety of Integrated Circuits (IC) and electronic elements attached to it. A peripheral unit is usually installed in a niche space to implement a specialized function. Wires and sockets are used to connect the mother board to the peripheral units for information exchange.

A peripheral unit is prone to worn-out after years of usage and needs to be replaced after worn-out. Other reasons such as a defect or a function upgrade can also trigger a replacement. A replacement of a peripheral unit is expensive because it requires delicately disconnecting wires connecting to the peripheral unit and reconnecting the wires for a new peripheral unit. If a peripheral unit is mounted to the mother board, detaching and remounting a peripheral unit needs repair tools such as a heat gun, and a reflow oven, which makes a replacement even more inconvenient.

The System-in-Package (“SiP”) technology has evolved rapidly in recent years. More and more peripheral units are made through SiP technology. SiP is a fully functional system or a sub-system enclosed in a format of IC package. SiP usually contains one or more IC chips plus other components such as passive elements, SAW filters, mechanical parts, and etc. The IC chips and other components are first mounted to a substrate, and then packaged through a transfer molding process to form a single package. A mold compound protects the IC chips and other components from dislocation, erosion, and damage. An antenna can be easily formed on a surface of a mold compound of a SiP. U.S. Pat. No. 8,199,518 and No. 8,058,714 respectively disclose a semiconductor package with an antenna.

### BRIEF SUMMARY OF THE INVENTION

A personal electronic device has its modules wirelessly connected for communications between the modules. The personal electronic device comprises a frame module, a peripheral module, a battery unit, and a plurality of power lines. The frame module and the peripheral module are each equipped with a wireless chipset and an antenna. The frame module has its central processing unit (“CPU”) chipset and wireless chipset enclosed by a frame module mold compound. The antenna of the frame module is disposed over a surface of the frame module mold compound. The peripheral module has its application-specific integrated circuit (“ASIC”) and its wireless chipset enclosed by a peripheral module mold compound. The antenna of the peripheral module is disposed over a surface of the peripheral module mold compound.

The communication between the frame module and the peripheral module is accomplished only through wireless signals. There are no wires and sockets for connecting the frame module to the peripheral module. Costs related to wires and/or sockets manufacture and installation are thereby reduced.

### BRIEF DESCRIPTION OF THE DRAWINGS

The novel features of the invention are set forth with particularly in the appended claims. A better understanding of the features and advantages of the present invention will be obtained by reference to the following detailed description that sets forth illustrative embodiments, in which the principle of the inventions are utilized, and the accompanying drawings of which:

FIG. 1 is a top view of a personal electronic device in accordance with an embodiment of the present invention;

FIG. 2 is a cross sectional view of the personal electronic device of FIG. 1, taken generally on line 2-2;

FIG. 3 is a top view of the peripheral module of the personal electronic device of FIG. 1; and

FIG. 4 is a cross sectional view of the peripheral module of FIG. 3, taken generally on line 4-4;

### DETAILED DESCRIPTION OF THE INVENTION

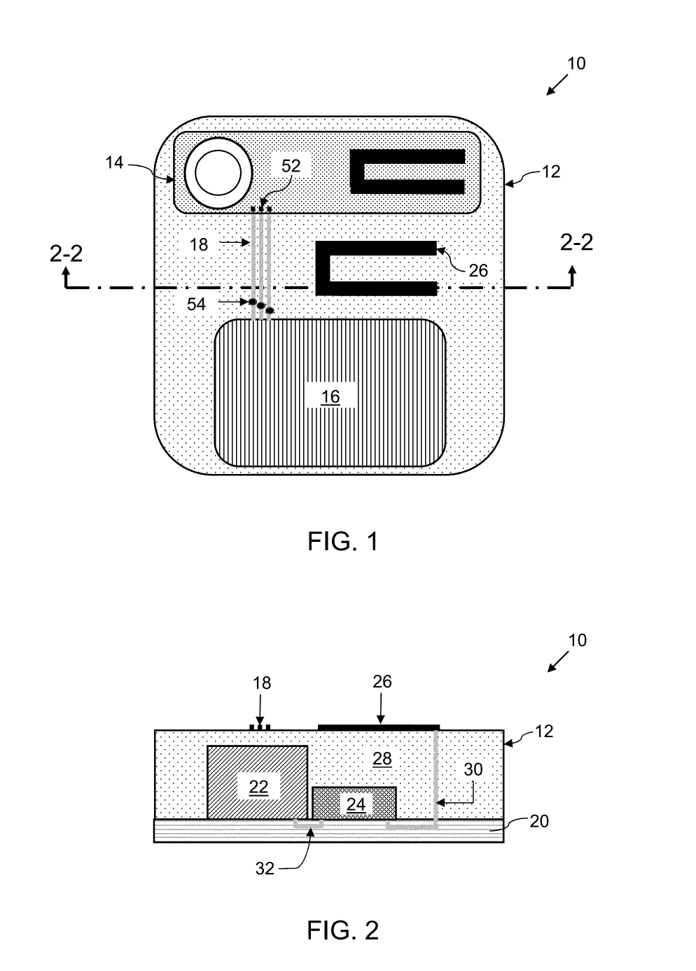

FIG. 1 is a top view of a personal electronic device in accordance with an embodiment of the present invention. The personal electronic device 10 comprises a frame module 12, a peripheral module 14, a battery unit 16, and a plurality of power lines 18. As shown in FIG. 1, two hollow spaces are formed in the frame module 12 to receive the peripheral module 14, and the battery unit 16. The plurality of power lines 18 is affixed to the frame module 12.

The frame module 12 acts as the brain of the personal electronic device 10, implementing the major functions such as control of peripheral modules, execution of application programs, and video or audio signal processing. As shown in FIG. 2, the frame module 12 comprises a substrate 20, a CPU chipset 22, a frame module wireless chipset 24, and a frame module antenna 26. The substrate 20 carries the CPU chipset 22 and the frame module wireless chipset 24. The frame module 12 transmits and receives wireless signal through the frame module wireless chipset 24 and the frame module antenna 26. The frame module wireless chipset 24 comprises a variety of radio frequency (“RF”) circuits such as resonant circuits, filters, matching networks, amplifiers, and mixers. The specific details of the RF circuits are within the knowledge of a person skill in the art and are not discussed here in order to not obscure the invention.

The frame module 12 further comprises a frame module mold compound 28 and signal lines 30 and 32. The frame module compound 28 overlies the substrate 20, the CPU chipset 22, and the frame module wireless chipset 24. The signal lines 30 and 32 electrically connect the CPU chipset 22, the frame module wireless chipset 24, and the frame module antenna 26. The frame module mold compound 28 is applied through transfer molding, injection molding, compression molding, or other molding processes. Molding material is either thermosetting or thermoplastic. The frame module antenna 26 is disposed over a surface of the frame module mold compound 28. Preferably, the frame module antenna 26 is made through coating and etching process. A frame module shielding conductive layer can be formed above the surface of the frame module mold compound to prevent electromagnetic interference (“EMI”) issues. The frame module antenna 26 is situated above and isolated from the frame module shielding conductive layer to prevent signal loss.

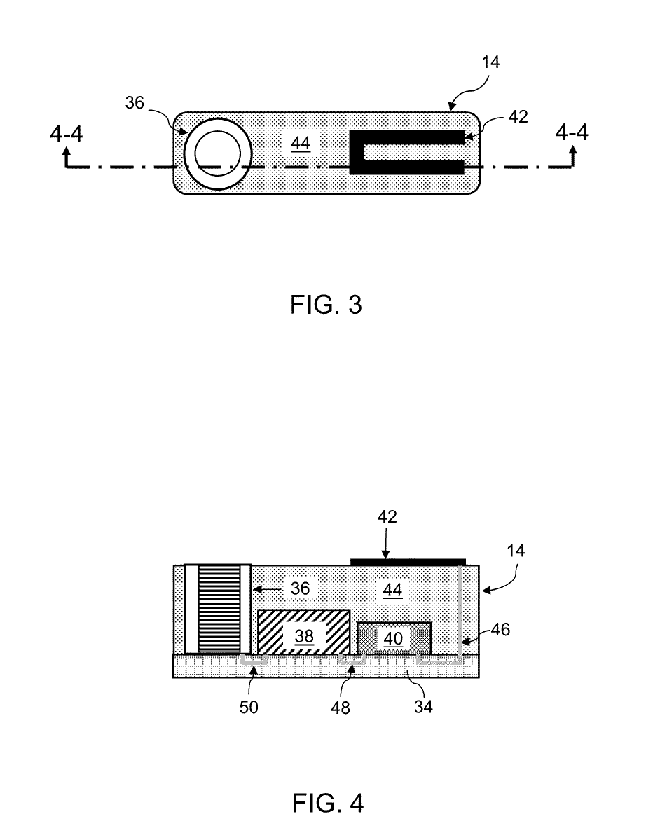

The peripheral module 14 performs at least one specialized function. For the purpose of illustration, the peripheral module 14 can be a camera unit, a scanner unit, a bio activity sensor, a display unit, a wireless communication unit, or an input-output unit. As shown in FIG. 3 and FIG. 4, the peripheral module 14 comprises a carrier 34, a functional element 36, and an ASIC 38. The functional element 36 and the ASIC 38 affix to the carrier 34. The functional element 36 is designed for performing the intended function of the peripheral module 14 and may contain a micro electro mechanical system (“MEMS”) component, an optical component, or a sensor component. The ASIC 38 is to assist the functional element 36 and/or to collect and store data from the functional element 36. The peripheral module 14 further comprises a peripheral module wireless chipset 40 and a peripheral module antenna 42 through which the peripheral module 14 sends and receives wireless signal to and from the frame module 12.

As shown in FIG. 4, the peripheral module 14 further comprises a peripheral module mold compound 44 and a plurality of signal lines 46, 48, and 50. The peripheral module mold compound 44 overlies the ASIC 38 and the peripheral module wireless chipset 40. The signal lines 46, 48, and 50 electrically connect the functional element 36, the ASIC 38, the peripheral module wireless chipset 40, and the peripheral module antenna 42. The peripheral module mold compound 44 is applied through transfer molding, injection molding, compression molding, or other molding processes. The peripheral module antenna 42 is disposed over a surface of the peripheral module mold compound 44. The peripheral module 14 further comprises a plurality of power terminals 52 for connecting to the power lines 18, and preferably, the peripheral module 14 has no terminals other than the power terminals 52. Furthermore, a peripheral module shielding conductive layer can be formed above the surface of the peripheral module mold compound 44 to prevent electromagnetic interference (“EMI”) issues. The peripheral module antenna 42 is situated above and isolated from the shielding conductive layer to prevent signal loss.

When a program executed in the CPU chipset 22 of the frame module 12 calls for an action in the peripheral module 14, an instruction will be sent from the CPU chipset 22 of the frame module 12 through the frame module wireless chipset 24 and the frame module antenna 26, and received by the peripheral module 14 through the peripheral module antenna 42 and the peripheral module wireless chipset 40. The ASIC 38 of the peripheral module 14 responds to the instruction by having the functional element 36 implement certain actions. Should the peripheral module 14 need to send information back to the frame module 12, the information will be sent by the peripheral module 14 through the peripheral module wireless chipset 40 and the peripheral module antenna 42, and received by the frame module 12 through the frame module antenna 26 and the frame module wireless chipset 24.

The battery unit 16 supplies power to the frame module 12 and the peripheral module 14 through the plurality of power lines 18. The plurality of power lines 18 has its ends soldered to or clamped to contact respective power terminals of the frame module 12 and the peripheral module 14. As shown in FIG. 1, the plurality of power lines 18 has a plurality of junctures 54 to branch the power lines 18.

While the invention has been disclosed with respect to a limited number of embodiments, numerous modifications and variations will be appreciated by those skilled in the art. It is intended, therefore, that the following claims cover all such modifications and variations that may fall within the true spirit and scope of the invention.

What is claimed is:

1. A personal electronic device comprising:
a frame module comprising a substrate, a central processing unit (“CPU”) chipset, a frame module wireless chipset, a frame module antenna, and a frame module mold compound overlying the CPU chipset and the frame module wireless chipset;
a peripheral module affixing to the frame module, comprising a carrier, a functional element, an application specific integrated circuit (“ASIC”), a peripheral module wireless chipset, and a peripheral module antenna; and
wherein the frame module and the peripheral module communicate with each other only through wireless signals.

2. The personal electronic device of claim 1 wherein the frame module antenna being disposed over a surface of the frame module mold compound.

3. The personal electronic device of claim 1 wherein the peripheral module further comprises a peripheral module mold compound overlying the ASIC and the peripheral module wireless chipset, and wherein the peripheral module antenna being disposed over a surface of the peripheral module mold compound.

4. The personal electronic device of claim 2 wherein the peripheral module further comprises a peripheral mold compound overlying the ASIC and the peripheral module wireless chipset, and wherein the peripheral module antenna being disposed over a surface of the peripheral module mold compound.

5. The personal electronic device of claim 4 further comprising a battery unit affixing to the frame module and a plurality of power lines for supplying power from the battery unit to the frame module and the peripheral module.

6. The personal electronic device of claim 5 wherein the peripheral module further comprises a plurality of power terminals for connecting to the power lines, and wherein the peripheral module is characterized by having no terminals other than the plurality of power terminals.
